(19) United States
(12) Patent Application Publication
(10) Pub. No.: US 2026/0210283 A1
(43) Pub. Date: Jul. 23, 2026

(54) TURBULENT JET CONTROLLED DIFFUSION COMBUSTION ENGINE

(71) Applicant: SAUDI ARABIAN OIL COMPANY, Dhahran (SA)

(72) Inventors: Xin Yu, Novi, MI (US); Anqi Zhang, Canton, MI (US); Andrew Baur, Whitmore Lake, MI (US); Jeffrey Hollowell, Commerce Township, MI (US)

(73) Assignee: ARAMCO SERVICES COMPANY, Houston, TX (US)

(21) Appl. No.: 19/033,352

(22) Filed: Jan. 21, 2025

(51) Int. Cl. F02B 17/00

(52) U.S. Cl. CPC F02B 17/005

(57) ABSTRACT

A turbulent jet controlled diffusion combustion system is disclosed. The system includes an engine block having a cylinder with an engine clearance volume defined by a lateral wall of the cylinder and an opposing surface of a piston. The piston moves up and down inside the cylinder where a passive prechamber is in fluid communication with the engine clearance volume and includes a spark plug and passive prechamber holes. A dual needle injector is disposed on the cylinder and includes a low flow needle for injecting a low flow fuel spray into the cylinder and a high flow needle for injecting a high flow fuel spray into the cylinder. The low flow needle is coaxial with the high flow needle and moves along a longitudinal direction inside the high flow needle.

### BACKGROUND

Combustion in an engine involves complex mechanisms such as diffusion combustion, compression combustion, mixing controlled combustion (MCC), etc. Diffusion combustion refers to that fuel spray mixes with air inside the cylinder before reaching the flame. The rate at which the fuel and air burn is determined by how quickly the fuel and air mix. Compression combustion, also known as compression ignition, refers to the fuel/air mixture spontaneously igniting after being compressed to a high temperature. Mixing controlled combustion (MCC) refers to that the rate of combustion is determined by the rate of fuel and air mixing.

Compression ignition engines using high cetane fuel such as diesel or Dimethyl ether (DME) can achieve robust diffusion combustion (mixing controlled combustion during fuel injection) due to proper match of cylinder thermal condition with an appropriate compression ratio and the ignition quality of the high cetane fuel. The initial auto-ignition of fuel is easy to control and robust even with varying environmental conditions, such as different intake air temperature, different dilution levels, etc. However, high cetane fuel is usually not as volatile and less able to promote mixing of air and fuel, which produces higher soot and nitrogen oxides emissions during diffusion or mixing controlled combustion. Throughout this disclosure, the terms “diffusion controlled combustion” and “mixing controlled combustion” are used interchangeably. On the other side, compression ignition engines using low cetane fuel or high-octane fuel, such as gasoline, ethanol, methanol, or ammonia, are more difficult to auto-ignite during mixing controlled combustion causing difficulty in controlling ignition timing and amount of premixed combustion featured with high pressure rise rate. The benefit of using high-octane fuel in diffusion combustion is the promotion of fuel vaporization and longer lift-off length for better mixing thus reducing soot and nitrogen oxides emissions. In addition, diffusion or mixing controlled combustion of high-octane fuel can be beneficial for high expansion ratio and high efficiency engine achieving high load operation with reduced pressure rise rate and peak cylinder pressure. Due to these reasons, there is a need for robust ignition control of high-octane fuel during initial diffusion combustion process.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a turbulent jet controlled diffusion combustion system. The system includes an engine block having a cylinder with an engine clearance volume defined by a lateral wall of the cylinder and an opposing surface of a piston, the piston configured to move up and down inside the cylinder, a passive prechamber in fluid communication with the engine clearance volume, the passive prechamber including a spark plug and one or more passive prechamber holes to permit fluid communication between the engine clearance volume and the passive prechamber, and a dual needle injector disposed on the cylinder and in fluid communication with the engine clearance volume, the dual needle injector comprising a low flow needle fluidly connected to a low flow injector nozzle disposed at an injector tip of the dual needle injector for injecting a low flow fuel spray, and a high flow needle fluidly connected to one or more high flow injector nozzles disposed at the injector tip for injecting a high flow fuel spray.

In one aspect, embodiments disclosed herein relate to aa injection method. The method includes providing fuel to a dual needle injector disposed on a cylinder of an engine, the cylinder comprising a passive prechamber having a spark plug and in fluid communication with a main chamber of the cylinder via one or more passive prechamber holes, the dual needle injector comprising a low flow needle and a high flow needle that are concentric to each other and form an annular chamber with respect to an internal wall of the dual needle injector, wherein the fuel is provided into the annular chamber, activating a low flow needle solenoid to move the low flow needle along a longitudinal direction to open a low flow injector nozzle disposed at an injector tip of the dual needle injector, injecting, in response to opening the low flow injector nozzle, a low flow fuel spray from the annular chamber through the low flow injector nozzle toward the one or more passive prechamber holes to enrich a relative fuel/air ratio of a fuel mixture inside the passive prechamber, activating a high flow needle solenoid to move the high flow needle along the longitudinal direction to open one or more high flow injector nozzles disposed at the injector tip of the dual needle injector, and injecting, in response to opening the high flow injector nozzle, a high flow fuel spray from the annular chamber through the one or more high flow injector nozzles into the main chamber, wherein the low flow needle solenoid and the high flow needle solenoid are activated independent of each other to independently control respective injection timing and injection duration of the low flow fuel spray and the high flow fuel spray.

In one aspect, embodiments disclosed herein relate to a dual needle injector disposed on a cylinder of an engine. The injector includes a low flow needle fluidly connected to a low flow injector nozzle disposed at an injector tip of the dual needle injector for injecting a low flow fuel spray, and a high flow needle fluidly connected to one or more high flow injector nozzles disposed at the injector tip for injecting a high flow fuel spray, wherein the low flow needle is coaxial with the high flow needle and moves along a longitudinal direction inside the high flow needle.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIGS. 1A-1C show a system in accordance with one or more embodiments.

FIG. 2 shows a method flowchart in accordance with one or more embodiments.

FIGS. 3A-3C show an example in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

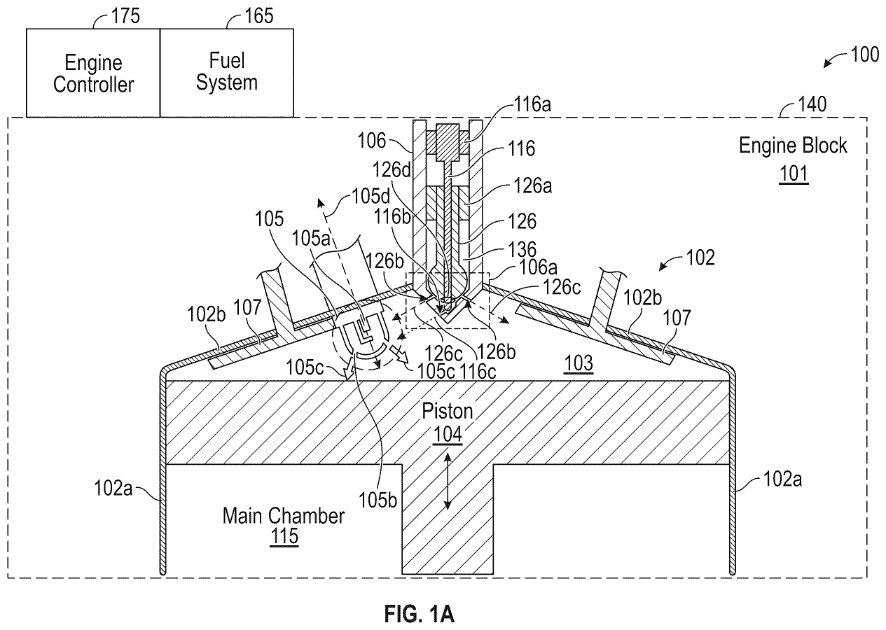

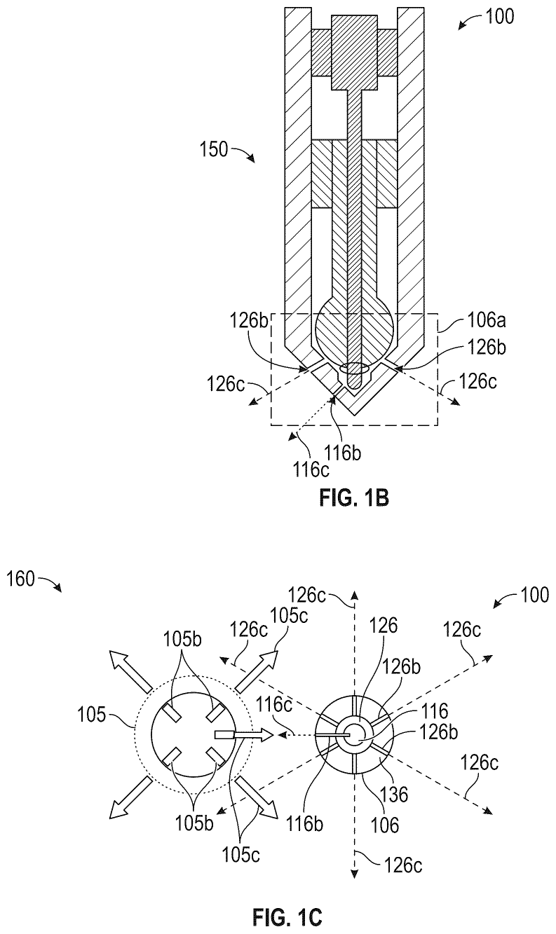

FIGS. 1A-1C show schematic diagrams in accordance with one or more embodiments. More specifically, FIGS. 1A-1C illustrate a side view (140), an expanded view (150), and a top view (160), respectively, of a turbulent jet controlled diffusion combustion system (100). In one or more embodiments, one or more of the modules and/or elements shown in FIGS. 1A-1C may be omitted, repeated, combined and/or substituted. Further, the illustrated turbulent jet controlled diffusion combustion system may include additional modules and/or elements that are not explicitly shown for clarity of the schematic diagram. Accordingly, embodiments disclosed herein should not be considered limited to the specific arrangements of modules and/or elements shown in FIGS. 1A-1C.

As shown in FIG. 1A, the turbulent jet controlled diffusion combustion system (100) includes an engine block (101) that houses a cylinder (102) with an engine clearance volume (103). A piston (104) moves up and down a hollow interior space of the cylinder (102), referred to as a main chamber (115). The hollow interior space of the cylinder (102) is formed by interior walls of the engine block (101) including a cylindrical wall (102a) and a lateral wall (102b). The lateral wall (102b) is referred to as the cylinder head against which the piston (104) compresses fluid content of the cylinder (102). The engine clearance volume (103) is an extended portion of the main chamber (115) and corresponds to the space defined by the lateral wall (102b) and an opposing surface of the piston (104) when the piston (104) reaches the top dead center (TDC) at end of the compression stroke. One or more intake or exhaust valves (107) are disposed on the lateral wall (102b). For example, there may be two valves for intake and exhaust events or four valves with two for intake and two for exhaust. Although the lateral wall (102b) has a cone shape as depicted in FIG. 1A, the lateral wall (102b) may have other shapes in different embodiments, such as a pent roof or flat roof shape. Further, the piston (104) can have flat top design or different bowl shape designs. Although the turbulent jet controlled diffusion combustion system (100) is shown in FIG. 1A as having one cylinder disposed in a vertical direction, the turbulent jet controlled diffusion combustion system (100) may also have multiple cylinders disposed in a horizontal direction, a slanted direction, or any other directions in an working environment, such as a vehicle, a factory, etc. where a fuel system (165) and an engine controller (175) are installed.

Within the engine clearance volume (103), a passive prechamber (105) protrudes from the lateral wall (102b). A prechamber in an engine is a small area, usually in the cylinder head, in which combustion is started before majority of the fuel enters into the main combustion chamber. The shape of the prechamber creates a vortex of fuel-air mixture flow resulting in a better fuel-air ratio. Prechamber ignition burns a small portion of the fuel inside the prechamber, which is connected to the main chamber by multiple small orifices. The combustion inside the prechamber generates hot gases, which penetrate the main chamber to increase the turbulence and ignite the fuel-air mixture on multiple sites within the main chamber. The passive prechamber (105) has an enclosure that defines an interior hollow space where a spark plug (105a) is disposed. The spark plug (105a) receives an electrical ignition signal (not shown) from the engine controller (175) to produce a spark that ignites air-fuel mixtures inside the passive prechamber (105). The engine controller (175) may include hardware component (e.g., electronic circuit, mechanical cam, etc.) and software component (e.g., computer programs) to generate the electrical ignition signal, such as an electrical voltage pulse.

The enclosure of the passive prechamber (105) includes one or more passive prechamber holes (105b) that permit fluid communication between the interior hollow space of the passive prechamber (105) and the engine clearance volume (103). More specifically, the one or more passive prechamber holes (105b) allow turbulent jets (105c) to emit from the interior hollow space into the engine clearance volume (103).

Further as shown in FIG. 1A, a dual needle injector (106) is disposed on the lateral wall (102b) and includes a low flow needle (116) and a high flow needle (126) that are concentric (i.e., coaxial) to each other and collectively form an annular chamber (136) with respect to an inner surface of the dual needle injector (106). The annular chamber (136) is in fluid communication with the engine clearance volume (103) via injector nozzles (116b, 126b) disposed at the tip of the dual needle injector (106). FIG. 1B illustrates the expanded view (150) of the tip of the dual needle injector (106). FIG. 1C illustrates the top view (160) of the concentric low flow and high flow needles forming the annular chamber (136). In one or more embodiments, the low flow needle (116) has a pointed tip with a diameter sufficient to close the low flow injector nozzle (116b) that is disposed at a lower position of the injector tip (106a). In one or more embodiments, the high flow needle (126) has an enlarged tip (e.g., having a ball shape) with a diameter sufficient to close all high flow injector nozzles (126b) that are disposed at a higher position of the injector tip above the low flow injector nozzle (116b). The high flow needle (126) has a hollow interior space and an opening (126d) (e.g., orifice) at the enlarged tip through both of which the low flow needle (116) penetrates to reach the low flow injector nozzle (116b) at a lower location in the annular chamber (136). Each diameter of the high flow needle (126), the high flow needle nozzle (126b), the opening (126d), the low flow needle (116), the low flow needle nozzle (116b) may vary depending on different engine sizes that use different injector sizes. In one or more embodiments, these diameters are chosen to allow a 0-5% of fuel mass to pass through the low flow needle (116) or conversely, 100-95% of fuel mass to pass through the high flow needle (126).

The low flow needle (116) and the high flow needle (126) are configured to control selective fuel injection from the annular chamber (136) into the engine clearance volume (103). The fuel is supplied from the fuel system (165) (e.g., fuel tank, high pressure fuel pump and associated tubing) into the annular chamber (136). The selective injection via a low flow injector nozzle (116b) is controlled by a low flow solenoid (116a) that causes the low flow needle (116) to move back and forth along a longitudinal direction of the dual needle injector (106) to open or close the low flow injector nozzle (116b). The selective injection via the one or more high flow injector nozzles (126b) is controlled by a high flow solenoid (126a) that causes the high flow needle (126) to move back and forth along the longitudinal direction of the dual needle injector (106) to open or close the one or more high flow injector nozzles (126b). A solenoid is an electromagnetic device that uses electric current induced magnetic forces to cause movements of a metallic portion of the flow needle and high flow needle. The low flow solenoid (116a) and high flow solenoid (126a) receive respective electrical control signals (not shown) from the engine controller (175) to move the low flow needle (116) and the high flow needle (126), respectively. During the high flow solenoid actuation, a reverse current is applied to the low flow solenoid to hold the low flow needle in place instead of moving with the high flow needle. The engine controller (175) may include hardware component (e.g., electronic circuit, mechanical cam, etc.) and software component (e.g., computer programs) to generate the electrical control signals, such as electrical current pulses. Further, the construction of the low flow solenoid (116a) and the high flow solenoid (126a) allow fluid flow to pass through without being obstructed in the annular chamber (136). In one or more embodiments, the low flow solenoid (116a) and the high flow solenoid (126a) are perforated or slotted or have enough diameter clearance for fluid flow and still provide sufficient magnetic force.

During the combustion operation, the passive prechamber (105) and the dual needle injector (106) allows two different spray configurations resulting in two different fuel plume patterns, referred to as a low flow fuel spray (116c) and a high flow fuel spray (126c). The low flow fuel spray (116c) and the high flow fuel spray (126c) are based on longitudinal movements of the low flow needle (116) and the high flow needle (126) that are independently controlled by respective solenoids (116a, 126a) to open and close the low flow injector nozzle (116b) and the high flow injector nozzle (126b) independent of each other. In one or more embodiments, a low flow fuel path of the low flow fuel spray (116c) is defined by the annular chamber (136) and a single low flow injector nozzle (116b) that is oriented toward a corresponding one of the passive prechamber holes (105b) while the axes (i.e., spraying orientations) of the low flow injector nozzle (116b) and the corresponding passive prechamber hole do not align on the same axis to avoid the hot turbulent jet (105c) from the corresponding passive prechamber hole moving towards the injector tip (106a) affecting its performance and durability.

The low flow fuel spray (116c) is used to introduce a fuel-air mixture to surround the outside of the corresponding passive prechamber nozzle. The introduced fuel/air mixture is pushed into the interior hollow space of the passive prechamber (105) via the corresponding passive prechamber nozzle during the compression stroke of the engine operation. The combustion of the pushed-in fuel-air mixture creates a pressure difference between the engine clearance volume (103) and the interior hollow space of the passive prechamber (105). The low flow injector nozzle (116b) is disposed at a lower physical location on the injector tip (106a) to facilitate access to the passive prechamber (105). As shown in FIG. 1C the top view (160) illustrates the access from the low flow injector nozzle (116b) to the corresponding passive prechamber hole of the passive prechamber (105). Because the passive prechamber (105) is relatively small in volume, e.g., between 1% to 3% of the engine clearance volume (103) when the piston (104) is at the top dead center of the compression stroke, the low flow fuel nozzle (116b) only needs to introduce a small quantity of fuel in the low flow fuel spray (116c) to enrich the relative fuel-air ratio inside the passive prechamber (105) to achieve near a unity value (e.g., 90%, 95%, 99%, or other ratio near 100% of the stoichiometric ratio) to enhance ignition quality of the spark plug (105a). For example, the fuel mass in the low flow fuel spray (116c) may correspond to between 1% to 3% of the total engine fuel in the engine clearance volume (103) when the piston (104) is at the top dead center of the compression stroke.

The high flow fuel spray (126c) is controlled by the high flow needle (126) and the high flow solenoid (126a) while having different spray orientations with respect to the low flow fuel spray (116c). The high flow fuel spray (126c) is used to inject a majority of the engine fuel into the engine clearance volume (103) to initiate diffusion or mixing controlled combustion to push the piston (104) down through the main chamber (115). The high flow injector nozzles (126b) are at higher physical locations on the injector tip (106a) above the low flow injector nozzle (116b) and may have different number of nozzles optimized for diffusion combustion with different piston designs. As shown in the top view (160) depicted in FIG. 1C, the orientations of the high flow fuel sprays (126c) are directed to avoid spraying fuel towards the passive prechamber (105) such that diffusion fuel spray does not impinge onto the surface of the passive prechamber (105) causing poor fuel vaporization and poor fuel/air mixing. The higher locations on the injector tip (106a) also allows flexibility to optimize the umbrella angle of the high flow injector nozzle (126b) according to the cylinder head and piston design. For example, the umbrella angle may be two times the angle measured between the high flow fuel spray (126c) and the longitudinal axis of the dual needle valve injector (106).

The concentric structure of the low flow and high flow needles in the dual needle valve injector (106) allows use of a single fuel flowing through the annular chamber (136) in a simplified structure for both low flow and high flow fuel sprays. The dual needle valve injector (106) also allows the use of different injection timing and different physical orientations between the low flow and high flow spray nozzles.

The passive prechamber (105) does not include any internal dedicated fuel injector for cost reduction compared to an active prechamber. One to 16 or more of the passive prechamber holes (105b) may be disposed on the passive prechamber (105) with straight axis configuration or tangential axis configuration. to achieve different flow characteristics in the passive prechamber (105). In the straight axis configuration where the longitudinal axes of the prechamber holes are perpendicular to parallel side wall of the prechamber (105), the prechamber holes may form opposing pairs and cause the air-fuel mixture flowing through the opposing prechamber holes to collide with each other forming non-structured flow. In the tangential axis configuration, the longitudinal axes of the prechamber holes do not oppose each other and cause the air-fuel mixture flow to form a swirl-like flow structure inside the prechamber. The umbrella angle of the passive prechamber holes (105b) can also be adjusted based on the cylinder head and piston design to avoid direct turbulent jet impingement on the surfaces of the dual needle valve injector (106). This umbrella angle may be two times the angle measured between the turbulent jets (105c) and the longitudinal axis (105d) of the passive prechamber (105).

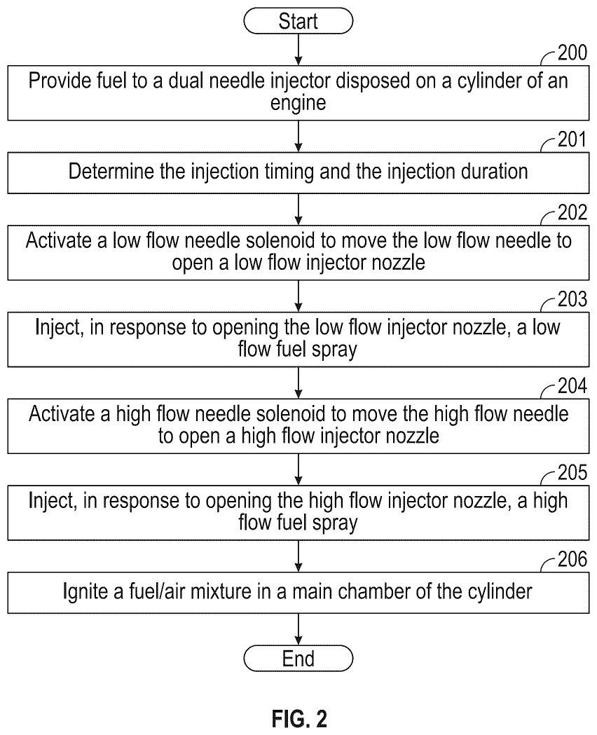

FIG. 2 shows a flowchart in accordance with one or more embodiments disclosed herein. One or more of the steps in FIG. 2 may be performed by the components of the turbulent jet controlled diffusion combustion system discussed above in reference to FIGS. 1A-1C. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

Initially in Step 200, fuel is provided to a dual needle injector disposed on a cylinder of an engine. The cylinder includes a passive prechamber having a spark plug and in fluid communication with a main chamber of the cylinder via one or more passive prechamber holes. The dual needle injector includes a low flow needle and a high flow needle that are concentric to each other and form an annular chamber with respect to an internal wall of the dual needle injector. Accordingly, the fuel is provided into the annular chamber of the dual needle injector.

In Step 201, the injection timing and the injection duration are determined. For example, the injection timing and duration may be determined based on a charge pressure in a main chamber of the cylinder. In one or more embodiments, the injection timing and the injection duration are optimized for various engine speeds and load conditions to prepare an ideal fuel-air ratio in the passive prechamber.

In Step 202, a low flow needle solenoid is activated to move the low flow needle along a longitudinal direction to open a low flow injector nozzle disposed at an injector tip of the dual needle injector.

In Step 203, in response to opening the low flow injector nozzle, a low flow fuel spray is injected from the annular chamber through the low flow injector nozzle toward the one or more passive prechamber holes to enrich a relative fuel-air ratio of a fuel mixture inside the passive prechamber. In one or more embodiments, the low flow injector nozzle is closed by deactivating the low flow needle solenoid after a pre-determined low flow injection duration, e.g., from a fraction of millisecond to a few milliseconds depending on the injector design and engine operation conditions.

In Step 204, a high flow needle solenoid is activated to move the high flow needle along the longitudinal direction to open one or more high flow injector nozzles disposed at the injector tip of the dual needle injector.

In Step 205, in response to opening the high flow injector nozzle, a high flow fuel spray is injected from the annular chamber through the one or more high flow injector nozzles into the main chamber. In one or more embodiments, the high flow injector nozzle is closed by deactivating the high flow needle solenoid after a pre-determined high flow injection duration, e.g., from a few milliseconds to tens of milliseconds depending on the injector design and engine operation conditions.

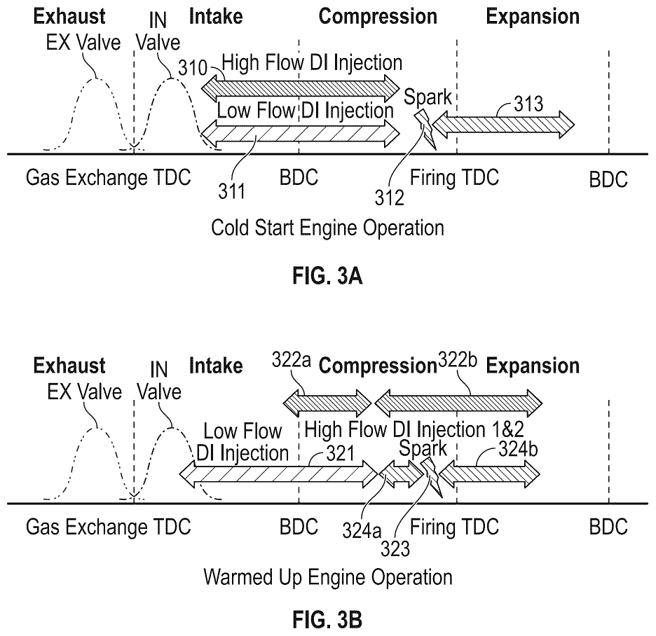

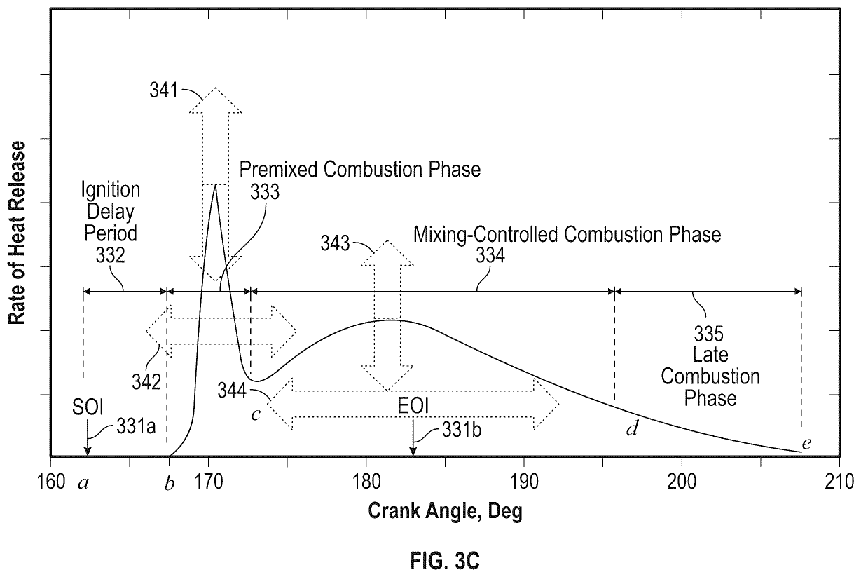

In one or more embodiments, the low flow needle solenoid and the high flow needle solenoid are activated independent of each other to independently control respective injection timing and injection duration of the low flow fuel spray and the high flow fuel spray. An example of independent activation of the solenoids is described in reference to FIGS. 3A-3C below.

In Step 206, at a spark ignition timing during a compression stroke of the engine, the spark plug is triggered to ignite the fuel mixture inside the passive prechamber. In response to igniting the fuel mixture, a turbulent jet is produced to emit through the one or more passive prechamber holes into the main chamber. Accordingly, the fuel-air mixture in the main chamber is ignited by the turbulent jet.

In one or more embodiments, in a cold start engine operation, the low flow fuel spray and the high flow fuel spray are injected concurrently during the intake stroke and the compression stroke of the engine to increase fuel-air mixing before the spark ignition timing to achieve a high temperature stoichiometric combustion. An example of the cold start engine operation is described in reference to FIG. 3A below.

In one or more embodiments, in a warmed up start engine operation, the low flow fuel spray is injected during the intake stroke and an early portion of the compression stroke of the engine, and the high flow fuel spray is injected during the compression stroke of the engine to produce a premixed combustion prior to the spark ignition timing and a mixing controlled combustion subsequent to the spark ignition timing. An example of the warmed up start engine operation is described in reference to FIG. 3B below.

In one or more embodiments, the spark ignition timing, the injection timing, and the injection duration are adjusted to control respective amount of the premixed combustion and the mixing controlled combustion.

FIGS. 3A-3C show an example in accordance with one or more embodiments. The example shown in FIGS. 3A-3C is based on the system and method described in reference to FIGS. 1A-1C and 2 above. In particular, FIGS. 3A-3C show example characteristics of the turbulent jet controlled diffusion combustion system depicted in FIGS. 1A-1C above. In one or more embodiments, one or more of the modules and/or elements shown in FIGS. 3A-3C may be omitted, repeated, combined and/or substituted. Accordingly, embodiments disclosed herein should not be considered limited to the specific arrangements of modules and/or elements shown in FIGS. 3A-3C.

FIG. 3A shows a cold engine operation of the turbulent jet controlled diffusion combustion system. FIG. 3B shows a warmed up engine operation of the turbulent jet controlled diffusion combustion system. In FIGS. 3A-3B, the term “TDC” stands for top dead center, and the term “BDC” stands for bottom dead center. Both terms refer to the position of a piston in a cylinder of an engine. TDC refers to when the piston reaches the top of its stroke, while BDC refers to when the piston is at the bottom. The distance between TDC and BDC is referred to as the stroke. A four-stroke engine operates with four strokes described below. In the intake stroke, the piston moves down from TDC (referred to as Gas exchange TDC) to BDC to draw in a fuel-air mixture. The intake valve is open during this stroke. In the compression stroke, the piston moves up from BDC to TDC (referred to as Firing TDC) to compress the fuel-air mixture. The intake valve is closed during this stroke. A spark plug ignites the mixture near the end of the compression stroke. In the expansion stroke (or power stroke), the high-pressure combustion products or gases force the piston down from TDC to BDC. This stroke produces the engine's power. In the exhaust stroke the piston moves up from BDC to TDC to expel the exhaust gases through the exhaust valve and restart the four-stroke cycle.

During engine cold start engine operation shown in FIG. 3A, all the engine fluids, hardware, and aftertreatment devices are cold which is not ideal for improving engine cold-start emission. Using the turbulent jet controlled diffusion combustion system described above, the engine cold start operation is improved by stoichiometric or rich (above stoichiometric) mixture operation using either the combination of high flow direct injection (DI) (310) and low flow DI injection (311) or a single high flow DI injection (310) during the intake stroke or compression stroke for sufficient fuel-air mixing before spark ignition (312). The injection timings (i.e., time durations represented by the double arrows) of the high flow and low flow injection nozzles are controlled using respective solenoids to produce the high flow fuel spray and low flow fuel spray of the high flow DI injection (310) and low flow DI injection (311), respectively. The relatively homogenous mixture in the passive prechamber is ignited by the spark plug at the time point referred to as the spark ignition timing (323) during the compression stroke. The resultant flame propagation inside the passive prechamber increases the pressure and temperature of the gases inside the prechamber that drives highly turbulent jets ejecting from the passive prechamber holes to the main chamber. The turbulent jets then ignite the well mixed fuel-air mixture in the main chamber to achieve high temperature stoichiometric or rich (above stoichiometric) combustion (313) to increase the heat in exhaust gas, resulting in high exhaust enthalpy. The high exhaust enthalpy improves the after-treatment catalyst light-off. The high temperature stoichiometric or rich combustion heats up the engine hardware and fluid more rapidly than conventional combustion operation. The spark ignition timing, i.e., timing of the spark ignition (312), can be further optimized according to the need of rapid heating of the engine cylinder (i.e., spark advance) or heating the after-treatment (i.e., spark retard). In summary, during cold engine operation, the high flow fuel spray and low flow fuel spray of the high flow DI injection (310) and low flow DI injection (311) are concurrent to each other and extend from the intake stroke into the compression stroke until the spark ignition timing (323) when both sprays/injections are terminated.

Once the engine is up to warm operating conditions as shown in FIG. 3B, the low flow DI injection (321) is maintained in the early intake or compression stroke to fuel the passive prechamber and allow sufficient mixing ready for spark ignition. For example, the low flow injector may use fuel pressure in the range of tens of bars to two thousands bars to charge the passive prechamber during intake against the compression pressure in the main chamber caused by the piston travelling from TDC to BDC. Then low flow DI injection (321) is stopped by shutdown of the solenoid of the low flow needle on the injector. During that time, high flow DI injection (322a) starts with high pressure fuel injection where the vaporized and mixed portion of fuel is ignited by the high temperature turbulent jets (i.e., turbulent jets (105c) depicted in FIGS. 1A-1C above) from the passive prechamber holes to produce combustion (324a). Before the high octane fuel auto ignites, the spark ignition (323) is controlled to start the combustion earlier than the autoignition. As shown in FIG. 3B, the combustion (324a) occurs after the spark ignition timing (323) without waiting for long ignition delay of the high-octane fuel. In this context, the combustion (324a) is referred to as premixed combustion, which is combustion that occurs when a fuel and air are mixed before they are ignited by spark.

Depending on the different engine speed and load operation, the spark plug is triggered at a controlled spark ignition timing (323). The spark ignition timing (323) and high flow DI injection (322a, 322b) can be timed differently to allow different levels of initial fuel-air mixing of the high flow DI fuel and therefore different amount of premixed combustion (324a). The high flow DI fuel refers to the injected fuel from the high flow fuel spray.

At lower engine load conditions where rate of pressure increase and peak cylinder pressure are low, the spark ignition timing (323) can be timed to be later than the high flow DI injection (322a) to allow some portion of the fuel premixed with cylinder gas mixture to increase pressure rise rate and shorten the overall burn duration for more efficient operation at lower engine loads. This can also be accomplished by considering the high flow DI injection as two events, one before spark ignition timing (323) for the premixed combustion (324a) and another one after spark ignition timing (323) for the mixing controlled combustion (324b). The first event allows more mixing time for preparing the premixed mixture to ensure that the premixed combustion (324a) is sufficient. At higher or peak engine load conditions where more constrained pressure rise rate and peak cylinder pressure are encountered, the spark ignition timing can be controlled to allow minimal fuel gas mixing for reduced amount of premixed combustion thus lower pressure rise rate and lower peak cylinder pressure. The independent timing control of the high flow DI injection, low flow DI injection, and spark ignition provide precise controllability of the amount of premixed combustion. In contrast, the amount of premixed mixture in a traditional compression ignition engine is controlled by the ignition delay of the fuel and the thermal condition of the mixture that are both difficult to control or predict since they are chemical kinetic driven non-linear processes.

In the turbulent jet controlled diffusion combustion system described above, altering the relative timing of the spark ignition timing (323) and the high flow DI injection (322a, 322b) can actively and precisely control the amount of premixed combustion (324a) and mixing controlled combustion (324b). FIG. 3C illustrates the controllability of heat release by independent ignition timing control with respect to the high flow DI injection. More specifically, FIG. 3C illustrates a chart of the rate of heat release versus the crank angle of the engine, which corresponds to the position of the piston throughout the exhaust, intake, compression, and expansion strokes of the cylinder. A full 4 stroke undergo a full 720 degrees of crank rotation with 180 degrees for each up and down stroke. FIG. 3C illustrates a 50 degree slice of the stroke because most of the combustion or chemical heat release process finishes in those 50 degree slice. As piston goes down during expansion stroke the pressure and temperature will decrease to the point where combustion is no longer sustained at those later crank angles. To make combustion engine operate efficiently, the combustion and chemical heat release needs to be as close as possible to the top dead center (referred to as the firing TDC) of the piston so the heat release increases the pressure rapidly to have a constant volume combustion.

In particular, the crank angle is divided into four sections. The section between crank angles a and b corresponds to the ignition delay period (332) where the crank angle a corresponds to the start of injection (SOI) (331a). The section between crank angles b and c corresponds to the premixed combustion phase (333). The section between crank angles c and d corresponds to the mixing controlled combustion phase (334) encompassing the end of injection (EOI) (331b). The section between crank angles d and e corresponds to the late combustion phase (335).

As shown in FIG. 3C, if the spark ignition timing is relatively later, i.e., producing the turbulent jets later than the DI injection timing thus igniting the pre-vaporized mixture later, heat release during the premixed combustion phase (333) will increase in amplitude (341) and duration (342) while heat release during the mixing-controlled combustion phase (334) will decrease in amplitude (343) and duration (344). And vice versa, if the spark ignition timing is relatively early, i.e., starting the turbulent jet with the DI injection timing thus igniting the initial pre-vaporized mixture, heat release during the premixed combustion phase (333) will decrease in amplitude (34) and duration (342) while heat release during the mixing-controlled combustion phase (334) will increase in amplitude (343) and duration (344). These amplitude and duration changes affect the pressure rise rate of the combustion as premixed combustion typically leads to higher amplitude heat release while mixing-controlled combustion leads to less amplitude of heat release.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A turbulent jet controlled diffusion combustion system comprising:
an engine block having a cylinder with an engine clearance volume defined by a lateral wall of the cylinder and an opposing surface of a piston;
the piston configured to move up and down inside the cylinder;
a passive prechamber in fluid communication with the engine clearance volume, the passive prechamber including a spark plug and one or more passive prechamber holes to permit fluid communication between the engine clearance volume and the passive prechamber; and
a dual needle injector disposed on the cylinder and in fluid communication with the engine clearance volume, the dual needle injector comprising:
a low flow needle fluidly connected to a low flow injector nozzle disposed at an injector tip of the dual needle injector for injecting a low flow fuel spray; and
a high flow needle fluidly connected to one or more high flow injector nozzles disposed at the injector tip for injecting a high flow fuel spray.

2. The turbulent jet controlled diffusion combustion system of claim 1, wherein the one or more passive prechamber holes comprises between 1 and 16 passive prechamber holes.

3. The turbulent jet controlled diffusion combustion system of claim 1, wherein the low flow needle is coaxial with the high flow needle and moves along a longitudinal direction inside the high flow needle.

4. The turbulent jet controlled diffusion combustion system of claim 1, wherein the low flow nozzle is disposed at an elevation below the one or more high flow nozzles on the injector tip.

5. The turbulent jet controlled diffusion combustion system of claim 1,
wherein the low flow needle is controlled by a low flow needle solenoid, producing the low flow fuel spray, and the high flow needle is controlled by a high flow needle solenoid, producing the high flow fuel spray, and
wherein the low flow needle solenoid and the high flow needle solenoid control the low flow needle and the high flow needle independently of each other.

6. The turbulent jet controlled diffusion combustion system of claim 1, wherein the low flow fuel spray and the high flow fuel spray are injected from an annular chamber between an internal wall of the dual needle injector and an outer wall of the high flow needle through the low flow injector nozzle and the one or more high flow injector nozzles into the engine clearance volume.

7. The turbulent jet controlled diffusion combustion system of claim 1 wherein:
the low flow injector nozzle is oriented toward the one or more passive prechamber holes such that the low flow fuel spray induces a turbulent jet to emit through the one or more passive prechamber holes;
the one or more high flow injector nozzles are oriented away from the one or more passive prechamber holes; and
the low flow fuel spray and the high flow fuel spray are not aligned with a direction of the turbulent jet emitted through the one or more passive prechamber holes.

8. The turbulent jet controlled diffusion combustion system of claim 1,
wherein the passive prechamber comprises 1-3 vol % of the engine clearance volume, and
wherein the low flow fuel spray introduces 1-3 vol % of the fuels to enrich a relative fuel/air ratio inside the passive prechamber to enhance ignition quality of the spark plug.

9. The turbulent jet controlled diffusion combustion system of claim 1, wherein the high flow injector nozzle is configured to inject between 97 and 99 vol % of the fuels into a main combustion chamber during combustion.

10. An injection method, comprising:
providing fuel to a dual needle injector disposed on a cylinder of an engine, the cylinder comprising a passive prechamber having a spark plug and in fluid
communication with a main chamber of the cylinder via one or more passive prechamber holes, the dual needle injector comprising a low flow needle and a high flow needle that are concentric to each other and form an annular chamber with respect to an internal wall of the dual needle injector, wherein the fuel is provided into the annular chamber;
activating a low flow needle solenoid to move the low flow needle along a longitudinal direction to open a low flow injector nozzle disposed at an injector tip of the dual needle injector;
injecting, in response to opening the low flow injector nozzle, a low flow fuel spray from the annular chamber through the low flow injector nozzle toward the one or more passive prechamber holes to enrich a relative fuel/air ratio of a fuel mixture inside the passive prechamber;
activating a high flow needle solenoid to move the high flow needle along the longitudinal direction to open one or more high flow injector nozzles disposed at the injector tip of the dual needle injector; and
injecting, in response to opening the high flow injector nozzle, a high flow fuel spray from the annular chamber through the one or more high flow injector nozzles into the main chamber,
wherein the low flow needle solenoid and the high flow needle solenoid are activated independent of each other to independently control respective injection timing and injection duration of the low flow fuel spray and the high flow fuel spray.

11. The injection method of claim 10, further comprising:
determining the injection timing and the injection duration based, at least in part, on a charge pressure in the main chamber.

12. The injection method of claim 10, further comprising:
optimizing the injection timing and the injection duration for a plurality of engine speeds and a plurality of load conditions; and
selecting a fuel/air ratio in the passive prechamber based on the optimized injection timing and injection duration.

13. The injection method of claim 10, further comprising:
triggering, at a spark ignition timing during a compression stroke of the engine, the spark plug to ignite the fuel mixture inside the passive prechamber;
producing, in response to igniting the fuel mixture, a turbulent jet to emit through the one or more passive prechamber holes into the main chamber; and
igniting, by the turbulent jet, the fuel/air mixture in the main chamber.

14. The injection method of claim 13,
wherein the low flow fuel spray and the high flow fuel spray are injected concurrently during an intake stroke and the compression stroke of the engine in a cold start engine operation to increase fuel/air mixing before the spark ignition timing to achieve a high temperature stoichiometric combustion.

15. The injection method of claim 13,
wherein the low flow fuel spray is injected during an intake stroke and an early portion of the compression stroke of the engine in a warm start engine operation to further produce the turbulent jet prior to triggering the spark plug;
wherein the high flow fuel spray is injected during the compression stroke of the engine in a warm start engine operation to produce a premixed combustion prior to the spark ignition timing and a mixing controlled combustion subsequent to the spark ignition timing.

16. The injection method of claim 15, further comprising:
adjusting the spark ignition timing, the injection timing, and the injection duration to control respective amount of the premixed combustion and the mixing controlled combustion.

17. A dual needle injector disposed on a cylinder of an engine, comprising:
a low flow needle fluidly connected to a low flow injector nozzle disposed at an injector tip of the dual needle injector for injecting a low flow fuel spray; and
a high flow needle fluidly connected to one or more high flow injector nozzles disposed at the injector tip for injecting a high flow fuel spray,
wherein the low flow needle is coaxial with the high flow needle and moves along a longitudinal direction inside the high flow needle.

18. The dual needle injector of claim 17, wherein the low flow nozzle is disposed at an elevation below the one or more high flow nozzles on the injector tip.

19. The dual needle injector of claim 17, further comprising:
a low flow needle solenoid for controlling the low flow needle to produce the low flow fuel spray; and
a high flow needle solenoid for controlling the high flow needle to produce the high flow fuel spray,
wherein the low flow needle solenoid and the high flow needle solenoid control the low flow needle and the high flow needle independently of each other.

20. The dual needle injector of claim 17, further comprising:
an annular chamber between an internal wall of the dual needle injector and an outer wall of the high flow needle,
wherein the low flow fuel spray and the high flow fuel spray are injected from the annular chamber through the low flow injector nozzle and the one or more high flow injector nozzles into a main chamber of the cylinder.
